(19) United States
(12) Patent Application Publication
(10) Pub. No.: US 2014/0149188 A1
(43) Pub. Date: May 29, 2014

(54) METHODS, APPARATUS AND SYSTEMS FOR GREEN SHIPPING PRACTICE ASSESSMENT

(71) Applicant: THE HONG KONG POLYTECHNIC UNIVERSITY, Hong Kong (HK)

(72) Inventors: Kee-hung Lai, Hong Kong (HK); Y.H. Venus Lun, Hong Kong (HK); Christina W.Y. Wong, Hong Kong (HK); Wai Ting Ngai, Hong Kong (HK); T. C. Edwin Cheng, Hong Kong (HK)

(73) Assignee: THE HONG KONG POLYTECHNIC UNIVERSITY, Hong Kong (HK)

(21) Appl. No.: 13/685,634

(22) Filed: Nov. 26, 2012

(51) Int. Cl. G06Q 10/06

(52) U.S. Cl. CPC G06Q 10/0639
USPC 705/7.38

(57) ABSTRACT

This invention discloses methods, apparatus and systems for assessing an extent of green shipping activities practised by a shipping company. The invention is based on enquiring the shipping company with questions in the dimensions of Company Policy and Procedure, of Shipping Documentation, of Shipping Equipment, of Shipping Cooperation, of Shipping Materials, and of Shipping Design Compliance. These six dimensions constitute six dimensions empirically validated to be essential for assessing the extent of green shipping activities. After the shipping company gives the answers, the answers to questions of each dimension are processed to yield an intermediate result. The resultant six intermediate results are then processed to evaluate the extent of green shipping activities, in order that all the six dimensions are considered in assessing the extent of green shipping activities.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### LIST OF REFERENCES

There follows a list of references that are occasionally cited in the specification. Disclosures of these references are incorporated by reference herein.
1. Armstron, J. S., & Overton, T. S. 1977. Estimating Nonresponse Bias in Mail Surveys. JMR, Journal of Marketing Research (pre-1986), 14(3): 396-396.
2. Bagozzi, R. P., Li, Y. J., & Phillips, L. W. 1991. Assessing Construct-Validity in Organizational Research. Administrative Science Quarterly, 36(3): 421-458.
3. Bagozzi, R. P., Yi, Y., & Phillips, L. W. 1991. Assessing Construct Validity in Organizational Research. Administrative Science Quarterly, 36(3): 421-458.
4. Churchill, G. A., Jr. 1979. A paradigm for developing better measures of marketing constructs. JMR, Journal of Marketing Research (pre-1986), 16(000001): 64-64.
5. Corbett, J. J., & Fischbeck, P. S. 2002. Commercial Marine Emissions and Life-Cycle Analysis of Retrofit Controls in a Changing Science and Policy Environment. Naval Engineers Journal, 114(1): 93-106.
6. Corbett, J. J., Wang, H., & Winebrake, J. J. 2009. The effectiveness and costs of speed reductions on emissions from international shipping. Transportation Research Part D: Transport and Environment, 14(8): 593-598.
7. Corbett, J. J., Winebrake, J. J., Green, E. H., Kasibhatla, P., Eyring, V., & Lauer, A. 2007. Mortality from Ship Emissions: A Global Assessment. Environmental Science & Technology, 41(24): 8512-8518.
8. DeVellis, R. F. 1991. Scale development: Theory and application. Newbury Park, Calif.: Sage Publications, Inc.
9. Eyring, V., Isaksen, I. S. A., Berntsen, T., Collins, W. J., Corbett, J. J., Endresen, O., Grainger, R. G., Moldanova, J., Schlager, H., & Stevenson, D. S. 2010. Transport impacts on atmosphere and climate: Shipping. Atmospheric Environment, 44(37): 4735-4771.
10. Formell, C., & Larcker, D. F. 1981. Evaluating structural equation models with unobservable variables and measurement error. JMR, Journal of Marketing Research (pre-1986), 18(000001): 39-39.
11. Hair, J. F., Black, W. C., Babin, B. J., & Anderson, R. E. 2010. Multivariate Data Analysis. Prentice Hall/Pearson.
12. Harbour, J. L. 2009. The Basics of Performance Measurement. Boca Raton: CRC Press.
13. Hu, L. t., & Bentler, P. M. 1999. Cutoff criteria for fit indexes in covariance structure analysis: Conventional criteria versus new alternatives. Structural Equation Modeling: A Multidisciplinary Journal, 6(1): 1-55.
14. Lai, K.-H., & Wong, C. W. Y. 2012. Green logistics management and performance: Some empirical evidence from Chinese manufacturing exporters. Omega, 40(3): 267-282.
15. Lai, K. H., Lun, Y. H. V., Wong, C. W. Y., & Cheng, T. C. E. 2011. Green shipping practices in the shipping industry: Conceptualization, adoption, and implications. Resources Conservation and Recycling, 55(6): 631-638.
16. Lai, K. H., Ngai, E. W. T., & Cheng, T. C. E. 2002. Measures for evaluating supply chain performance in transport logistics. Transportation Research Part E—Logistics and Transportation Review, 38(6): 439-456.
17. Lai, K. H., Wong, C. W. Y., & Cheng, T. C. E. 2010. Bundling digitized logistics activities and its performance implications. Industrial Marketing Management, 39(2): 273-286.
18. Lai, K. H., Wong, C. W. Y., & Cheng, T. C. E. 2012. Ecological modernisation of Chinese export manufacturing via green logistics management and its regional implications. Technological Forecasting and Social Change, 79(4): 766-770.
19. Lindell, M. K., & Whitney, D. J. 2001. Accounting for common method variance in cross-sectional research designs. Journal of Applied Psychology, 86(1): 114-121.
20. Lindstad, H., Asbjørnslett, B. E., & Strømman, A. H. 2011. Reductions in greenhouse gas emissions and cost by shipping at lower speeds. Energy Policy, 39(6): 3456-3464.
21. Lun, V. Y. H., Lai, K.-H., & Cheng, T. C. E. 2010. Shipping and logistics management (1 ed.). Germany: Springer Verlag.
22. Lun, Y. H. V., Lai, K. H., Ng, C. T. D., Wong, C. W. Y., & Cheng, T. C. E. 2011. Editorial: Research in shipping and transport logistics. International Journal of Shipping and Transport Logistics, 3(1): 1-5.
23. Marsh, H. W., & Hocevar, D. 1985. Application of confirmatory factor analysis to the study of self-concept: First- and higher order factor models and their invariance across groups. Psychological Bulletin, 97(3): 562-582.
24. Nunnally, J. C., & Berstein, I. H. 1994. Psychometric theory (3 ed.). New York: McGraw-Hill.
25. Podsakoff, P. M., MacKenzie, S. B., Lee, J. Y., & Podsakoff, N. P. 2003. Common method biases in behavioral research: A critical review of the literature and recommended remedies. Journal of Applied Psychology, 88(5): 879-903.
26. Viana, M., Amato, F., Alastuey, A. s., Querol, X., Moreno, T., García Dos Santos, S. I., Herce, M. a. D., & Fernández-Patier, R. a. 2009. Chemical Tracers of Particulate Emissions from Commercial Shipping. Environmental Science & Technology, 43(19): 7472-7477.
27. Wong, C. W. Y., Lai, K.-H., & Cheng, T. C. E. 2009. Complementarities and alignment of information systems management and supply chain management. International Journal of Shipping and Transport Logistics, 1(2): 156-171.
28. Wong, C. W. Y., Lai, K.-H., & Ngai, E. W. T. 2009. The role of supplier operational adaptation on the performance of IT-enabled transport logistics under environmental uncertainty. International Journal of Production Economics, 122(1): 47-55.
29. Wong, C. W. Y., Lai, K. H., Cheng, T. C. E., & Lun, V. Y. H. 2011. The roles of stakeholder support and procedure-oriented management on asset recovery. International Journal of Production Economics, 135(2): 584-594.
30. Wong, C. Y., Boon-itt, S., & Wong, C. W. Y. 2011. The contingency effects of environmental uncertainty on the relationship between supply chain integration and operational performance. Journal of Operations Management, 29(6): 604-615.
31. Yang, M. 2011. Shipping and Maritime Transport. In O. N. Editor-in-Chief: Jerome (Ed.), Encyclopedia of Environmental Health: 33-40. Burlington: Elsevier.

### FIELD OF THE INVENTION

The present invention relates to questionnaires having questions for enquiring a shipping company on its green shipping practices, and methods, apparatus and systems for assessing an extent of green shipping activities practised by the shipping company that replies to such questions.

### BACKGROUND

Public concerns over environmentally friendly operations and resource conservation in the shipping sector have been on the rise. Shipping refers to cargo movement between two or more geographic locations in all modes including air, land, and sea transportation. As ships serve more than 80% of the world trade by volume (UNCTAD, 2011), sea transportation is the most popular shipping method by traders. Considering the global importance of seaborne trade, this study defines shipping as cargo movement by ships with intermodal connections and specifically investigates green shipping practices (GSP) in sea transportation. Shipping facilitates global trade but generates environmental pollution (e.g., CO₂ emission, oil spill). While most shipping research studies focus on cost saving and service enhancement in order to achieve productivity gains, the environmental management aspect of shipping operations remains largely unexplored in the literature (Lun, Lai, Ng, Wong, & Cheng, 2011). Due to the escalating environmental awareness in business, the shipping industry is increasingly expected to take environmental responsibility such that shipping operations and processes become more environmentally friendly in serving world trade. In response, shipping firms pursue GSP in hope of mitigating the environmental damages caused by their activities. The present invention defines GSP broadly as the handling and distribution of cargoes in an environmentally sustainable way with a view to reducing waste creation and conserving resources in performing shipping activities.

Industrialization and globalization have bolstered international trade and the total seaborne trade had tripled from 1990 to 2011 (UNCTAD, 2011). Although shipping by maritime routes causes relatively less pollution compared with other transportation modes, it can significantly harm the environment due to its enormous industry scale, and shipping activities can damage the environment in multiple ways, e.g., consumption of natural resources (e.g., fuel consumption), emissions of greenhouse gases (GHG) (e.g., CO₂), and discharge of waste from vessel operations (e.g., ballast water and oil). In view of a growing emphasis on environmental protection as part of corporate social responsibility, shipping firms have begun to recognize the importance of “greening” their activities in serving the global community through their role in supporting international trade.

The intensifying community and consumer pressures on environmentally responsible operations have prompted shipping firms to implement GSP as means for greening their operations. For instance, many mega carriers such as OOCL, Hapag-Lloyd, and CMA CGM value the potential performance benefits of environmental management and embrace GSP as a part of their operations strategy to seek sustainable growth in business. Meanwhile, due to stricter regulations mandating environmentally responsible practices (e.g., The International Maritime Organization (IMO) International Convention for the Prevention of Pollution from Ships), shipping firms are expected to effectively integrate environmental concerns into their daily operations. They find it advantageous to pursue proactive environmental-based operations such as GSP to cope with institutional pressures (e.g., stricter regulatory requirements), which will intensify in the years ahead.

In the emerging but neglected research topic of green shipping, it is desirable to understand the construct of GSP implementation and develop an empirically validated measurement scale for evaluating implementation GSP in shipping firms. Measurement is a fundamental activity of science and is usually associated with other scientific questions (DeVellis, 1991). Specifically, performance measurement is the process of measuring actual outcomes or the end goal of performance, as well as the means of achieving those outcomes as represented by in-process measures (Harbour, 2009). Therefore, an absence of measurement scales for evaluating the scale and scope of shipping firms in greening their activities is a potential barrier to their effective implementation of GSP.

Shipping embraces all the activities concerning the movement of cargoes among different parties within a transportation chain, whereby the activities involve the integration of upstream shippers and downstream consignees (Lun, Lai, & Cheng, 2010). Therefore, implementation of GSP needs coordination of internal functions within a shipping firm and the external operations of partner firms, e.g., shippers, consignees, logistics services provides, and intermodal transport operators, and other trade related firms, along the transportation chain. However, stakeholders, such as shippers, consignees, and carriers, tend to emphasize the performance areas that serve their best interest. For instance, carriers may focus on operational efficiency, while shippers are more concerned with service effectiveness along the same transportation chain (Lai, Ngai, & Cheng, 2002). The differences in the views of GSP would lead to inconsistency in the performance measures valued by different member firms and compromise chain-wide performance as a consequence. Given the divergent viewpoints on GSP, it would be difficult for shipping firms, as well as the different parties involved, to effectively evaluate the performance of their practices on a chain-wide basis.

Upon conducting a literature search on environment-based shipping practices, we find a serious lack of tools for evaluating the implementation of GSP. Furthermore, the extant studies concerning environmental management practices in the shipping discipline are mostly descriptive in nature with little empirical evidence about the aspects of GSP that are implemented in shipping firms. There is a need in the art for an empirically validated tool that can be used for evaluating GSP implementation for a shipping company.

### SUMMARY OF THE INVENTION

A first aspect of the present invention is a method for assessing an extent of green shipping activities practised by a shipping company. The method comprises presenting a plurality of green-shipping-related questions to the shipping company in order that the shipping company is enquired to provide an answer to each of the green-shipping-related questions. The plurality of green-shipping-related questions comprises: one or more questions related to a dimension of Company Policy and Procedure; one or more questions related to a dimension of Shipping Documentation; one or more questions related to a dimension of Shipping Equipment; one or more questions related to a dimension of Shipping Cooperation; one or more questions related to a dimension of Shipping Materials; and one or more questions related to a dimension of Shipping Design Compliance. These six dimensions are validated to be essential for assessing the extent of green shipping activities. The extent of green shipping activities can be evaluated through processing the answers to the one or more questions related to each of the six identified dimensions. Optionally, the answer to each of the green-shipping-related questions is selected from one of five candidate answers, where the five candidate answers are based on a 5-point Likert scale.

It is preferable that an entirety of the one or more questions related to each of the six dimensions comprises one or more questions each of which is concerned with any of measurement items shown in FIG. 8 for the dimension under consideration, or equivalents of such measurement items.

Preferably, the method further comprises: processing the answers to the one or more questions related to the dimension of Company Policy and Procedure so as to generate a first intermediate result; processing the answers to the one or more questions related to the dimension of Shipping Documentation so as to generate a second intermediate result; processing the answers to the one or more questions related to the dimension of Shipping Equipment so as to generate a third intermediate result; processing the answers to the one or more questions related to the dimension of Shipping Cooperation so as to generate a fourth intermediate result; processing the answers to the one or more questions related to the dimension of Shipping Materials so as to generate a fifth intermediate result; and processing the answers to the one or more questions related to the dimension of Shipping Design Compliance so as to generate a sixth intermediate result. The method may further comprise evaluating the extent of green shipping activities by processing these six intermediate results neglecting any one of them.

A second aspect of the present invention is a questionnaire configured to enquire a shipping company regarding its GSP. The questionnaire comprises: one or more questions related to a dimension of Company Policy and Procedure; one or more questions related to a dimension of Shipping Documentation; one or more questions related to a dimension of Shipping Equipment; one or more questions related to a dimension of Shipping Cooperation; one or more questions related to a dimension of Shipping Materials; and one or more questions related to a dimension of Shipping Design Compliance. These six dimensions are validated to be essential for assessing the extent of green shipping activities practised by the shipping company. Optionally, the questionnaire further comprises a set of five candidate answers based on a 5-point Likert scale, such that each of the one or more questions related to any of the six identified dimensions is configured to be answered with an answer selected from one of the five candidate answers.

Again, preferably an entirety of the one or more questions related to each of the six dimensions comprises one or more questions each of which is concerned with any of measurement items shown in FIG. 8 for the dimension under consideration, or equivalents of such measurement items.

A third aspect of the present invention is related to systems for assessing an extent of green shipping activities practised by a shipping company, or each of a number of shipping companies. One system comprises the disclosed questionnaire, thus allowing a shipping company to provide answers to questions therein. This system further includes a data-processing apparatus configured to evaluate the extent of green shipping activities practised by the shipping company when receiving the answers. Another system is configured to enquire a plurality of shipping companies on their GSP and to assess an extent of green shipping activities practised by each of the shipping companies. In the system, there is a questionnaire generating and dispatching unit configured to generate a plurality of questionnaires and to dispatch one of the questionnaires to each of the shipping companies. In particular, each of the questionnaires is the questionnaire disclosed in the second aspect of the invention. The system further comprises a data-processing apparatus configured to evaluate the extent of green shipping activities practised by any one of the shipping companies when receiving the answers such one shipping company.

### BRIEF DESCRIPTION OF THE DRAWINGS

FIG. 1 is a flowchart showing the methodology adopted in the validation of the GSP measurement scale.

FIG. 2 shows a first-order measurement model for GSP implementation.

FIG. 3 shows a second-order measurement model for GSP implementation.

FIG. 4 shows the results of reliability, CITC and CFA, in the validation of the GSP measurement scale.

FIG. 5 shows the results of discriminant validity checks and the results of CFA on GSP, both sets of results being obtained in the validation of the GSP measurement scale.

FIG. 6 lists the measurement items proposed for each of the six identified dimensions, the items being tested in the validation of the GSP measurement scale.

FIG. 7 depicts a flowchart illustrating a method for assessing an extent of green shipping activities practised by a shipping company in accordance with an embodiment of the present invention.

FIG. 8 provides a table listing the six identified dimensions empirically validated to be essential for assessing an extent of green shipping activities, and the measurement items associated with each of the identified dimensions.

FIG. 9 depicts a system for assessing an extent of green shipping activities practised by a shipping company, the system comprising a questionnaire and a processing unit to evaluate the extent of green shipping activities based on the shipping company's answers to questions of the questionnaire.

FIG. 10 depicts a system for assessing extents of green shipping activities practised by a plurality of shipping companies.

### DETAILED DESCRIPTION

The present invention is developed based on the Inventors' original research on GSP implementation.

### A. Conceptualization of GSP

GSP implementation is increasingly recognized as an important management approach to help lessen the environmental damages caused by shipping activities. GSP are concerned with handling and distributing cargoes in a sustainable way, taking account of such environmental issues as waste reduction and resource conservation in shipping management. Shipping activities involve coordination with various parties along the transportation chain. The nature of such operations suggests that the effective implementation of GSP necessitates cross-functional cooperation rather than being confined to a single organizational unit. For example, GSP require cooperation with equipment suppliers for the selection of environmentally friendly shipping facilities. Examples include eco-labeling of resources such as shipping crates and totes for reuse, cooperation with equipment suppliers on environmental objectives, and environmental audits of suppliers' internal management systems. Cooperation with customers and shippers on eco-design in cargo handling and shipments is also highly desirable. This includes customer involvement in cleaner delivery such as enforcement of programmes for recycling, vehicle idling, packing waste collection, and using green packing materials.

Different interpretations of GSP can lead to inconsistency in performance evaluation, which compromises the implementation outcomes. GSP have been conceptualized in various ways, ranging from the perspective of natural science to technological advancement, as well as business management. The former conceptualization considers GSP as means helpful for shipping firms to ease the damages caused by their operations to the natural environment. Corbett et al. (2007) and Eyring et al. (2010) examined emission-related atmospheric problems arising from shipping activities and they explained the association between vessel operations and atmospheric pollution consequences (e.g., global warming, acid rain, climate changes). Their studies analyze the adverse environmental impacts brought by shipping activities with recommendations suggested to mitigate the relevant issues. Yang (2011) investigated the toxicity and ecological risks in the marine environment associated with shipping management. The study covers various aspects of pollution generated by shipping operations, which include ballast water discharge, exhaust emissions, and oil pollution. In addition, he carried out a toxicology assessment to evaluate the severity of environmental impact caused by chemical leakage from hull during operations. Toxic chemicals such as tri-butyltin (TBT) (i.e., a typical anti-fouling paint) are commonly found in raw materials for vessel construction, where the leakage of such chemicals can result in severe ecological impact.

Alternatively, GSP are sometimes considered as breakthroughs and advancements in shipbuilding technologies with a focus on cost reduction and productivity improvement through effective use of energy, while minimizing shipping-caused environmental damages. Coupled with technological advancement, we have seen the use of modifications of vessel engine systems, application of chemical tracers, and use of alternative fuels for vessel operations as means to green the shipping activities. All these initiatives are adopted with the aim to reduce the environmental harm caused by shipping navigations (Corbett & Fischbeck, 2002; Eyring et al., 2010; Viana et al., 2009). The environmental and financial consequences of technological advancement for shipping operations have become popular research topics in the literature (e.g., Viana et al., 2009).

Meanwhile, GSP implementation is often associated with behavioral changes to run and manage shipping companies such as continuous improvements of vessel operation procedures. Two groups of researchers have investigated the association between vessel speed and emission level (Corbett, Wang, & Winebrake, 2009; Lindstad, Asbjørnslett, & Strømman, 2011). They built mathematical models to correlate vessel speed, profit, and CO₂ emissions, and both studies found that vessel speed reduction would effectively reduce CO₂ emissions, while maintaining profitability. From the commercial perspective, shipping firms have also begun to adopt new business practices for improving the environmental performance of their operations. For example, CMA CGM has introduced the “eco-speed” programme to reduce the speed of its vessels. Mitsui O.S.K. Lines (MOL) has implemented a newly established system called “ECO SAILING” and Maersk has developed the Voyage Efficiency System (VES). OOCL has launched a fuel saving programme to cut down greenhouse gases, especially CO₂. These practices highlight that shipping firms focus on the most environmentally friendly operations in order to minimize fuel consumption while striving to optimize vessel performance. GSP are also a viable management approach to satisfy the escalating environmental expectations and requests of stakeholders of shipping firms. The greening of shipping operations can help fulfill various voluntary environmental requirements such as ISO 14000 certification and ISM Code. There exist various models to fulfill the environmental purposes in shipping operations. For instance, Celik (2009) developed an Integrated Environmental Management System (IEMS) for the shipping industry. The model is developed by integrating the Analytic Hierarchy Process (AHP) and Fuzzy Axiomatic Design (FAD) concepts. Shipping firms may use the model to establish the managerial and operational interface on environmental management issues to comply with the requirements of the ISM Code and the ISO 14001 standard simultaneously.

The importance of GSP for the shipping industry is obvious, but measures for evaluating GSP implementation remain inconclusive. Based on an earlier exploratory research (Lai, Lun, Wong, & Cheng, 2011), we empirically investigate the environmental concerns of shipping firms; in particular, we develop the construct and measurement of GSP implementation in this study. Specifically, we classify the GSP implementation of shipping firms for reducing waste creation and conserving resources into six dimensions. These GSP implementation dimensions in shipping operations are useful for shipping firms to yield environmental as well as productivity benefits. Shipping firms may use these different aspects of environmental shipping operations to identify improvement areas in their own operations for achieving eco-efficiency. The six GSP implementation dimensions are illustrated as follows, supplemented with examples from a case study on Maersk.

1. Company Policy and Procedure (CPP):

CPP is concerned with corporate commitment to a vision or culture of sustainability in a shipping firm. Examples include commitment to GSPs from senior managers, support for GSPs from mid-level managers, cross-functional cooperation for green practices, environmental compliance and auditing programs, ISO 14001 certification, environmental policy, and system implementation. For instance, Maersk is committed to the protection of the environment and accords a high priority on environmental issues in managing its business. Maersk's environmental policy is “we will honor environmental commitments by minimizing the environmental impact of our business through constant care (i.e., careful use of resources, optimization of operations and handling of waste streams), and striving continuously for improvement in our environmental performance and pollution prevention across all our activities”.

2. Shipping Documentation (SD):

SD focuses on promoting reductions in resource utilizing such as paper for documenting shipping activities. Examples of shipping activities include booking request, booking confirmation, shipping instructions, invoice, and remittance advice. To reduce the use of paper and simplify the shipping processes, Maersk offers an “End-to-End EDI Solutions” to automatically synchronize the sharing of data across its customers and business partners, significantly cutting down paperwork, reducing processing speed, and decreasing the possibility of errors by transferring data without manual intervention.

3. Shipping Equipment (SE):

SE advocates the use of eco-design for such shipping equipment as cartons and pallets. This also extends to collaboration with suppliers to use environmentally friendly shipping equipment to pursue environmental objectives. Examples include eco-labeling of resources such as shipping crates and totes for reuse, cooperation with equipment suppliers on environmental objectives, environmental audit of suppliers' internal management, suppliers' ISO 14001 certification, and evaluation of second-tier equipment suppliers' green practices. The container is the most important equipment in container shipping. Many refrigerated containers use chlorofluorocarbon (CFC), which has been blamed for contributing to the deterioration of the protective ozone layer and to the worsening of global warming. To eliminate the emission of ozone depleting substances, Maersk has abandoned the use of CFC and replaced it with other more environmentally friendly types of refrigerants. In addition, Maersk uses alternative materials to develop container flooring. So far, Maersk has produced more than 10,000 containers with floorboards made of bamboo, which is a quick growing grass that can be harvested every three to four years.

4. Shipper Cooperation (SC):

SC concerns cooperation with shippers in eco-design for cargo operations. Examples include working with customers on eco-design in cargo handling and shipments, involving customers in cleaner delivery such as enforcement of programs for recycling, vehicle idling, packing waste collection, and using green packing materials. Maersk has collaborated with a number of firms to embark on environmental management initiatives. For instance, the Clean Cargo Working Group (CCWG) involves shippers and carriers in the shipping industry dedicated to sustainable product transportation by ocean.

5. Shipping Materials (SM):

SM emphasizes reducing, recycling, and reusing shipping materials. It also extends to the environmental design of packaging materials, e.g., packaging and cartons. Examples include sale of excess equipment and facilities, sale of used shipping materials such as packaging and cartons, and collection of used oil for sale. For example, Maersk has a company policy on vessel recycling. This policy requires a vessel to be rigorously checked before it is delivered to a recycling yard. Such checking procedures ensure that recycled ships are free from oil spillage, toxic water discharge, and harms generated from the disposal of all the shipping materials. The procedures involve conducting a radiation survey and auditing hazardous materials with the aim of minimizing the environmental impacts caused by vessel recycling. On the other hand, new vessels are designed and built to ensure a very high recycling ratio.

6. Shipping Design Compliance (SDC):

SDC seeks to take measures in compliance with such environmental requirements as energy saving, reuse of shipping equipment, reduction of environmental damage, and recycling and recovery of waste. Examples include design of shipping activities and equipment for reduced consumption of materials and energy, design of shipping activities for reuse, recycling and recovery of materials, and design of equipment to avoid or reduce the use of polluting energy. Optimized voyage planning is an essential tool for fuel savings. Maersk has developed the Voyage Efficiency System (VES) to identify the most fuel-efficient route and pursue a just-in-time steady running strategy. In addition, the Los Angeles Harbor Commission has launched the Vessel Speed Reduction (VSR) Program, under which vessels reduce speed to a voluntary 12-knot speed limit within 20 nautical miles of Point Fermin. Maersk is participating in the Ports of Los Angeles/Long Beach Vessel Speed Reduction Program.

Based on the above conceptualization, we examine two models of GSP implementation in the present study. We test the six-factor structure of the GSP construct in a first-order model, where CPP, SD, SE, SC, SM, and SDC correlate among themselves in measuring the same theoretical construct, i.e. GSP implementation, and in an alternative second-order model, where we treat the construct as a higher order model governing the covariance of the six dimensions of GSP implementation.

### B. Methodology Used in Validating the GSP Measurement Scale

### B.1 Developing the GSP Implementation Construct

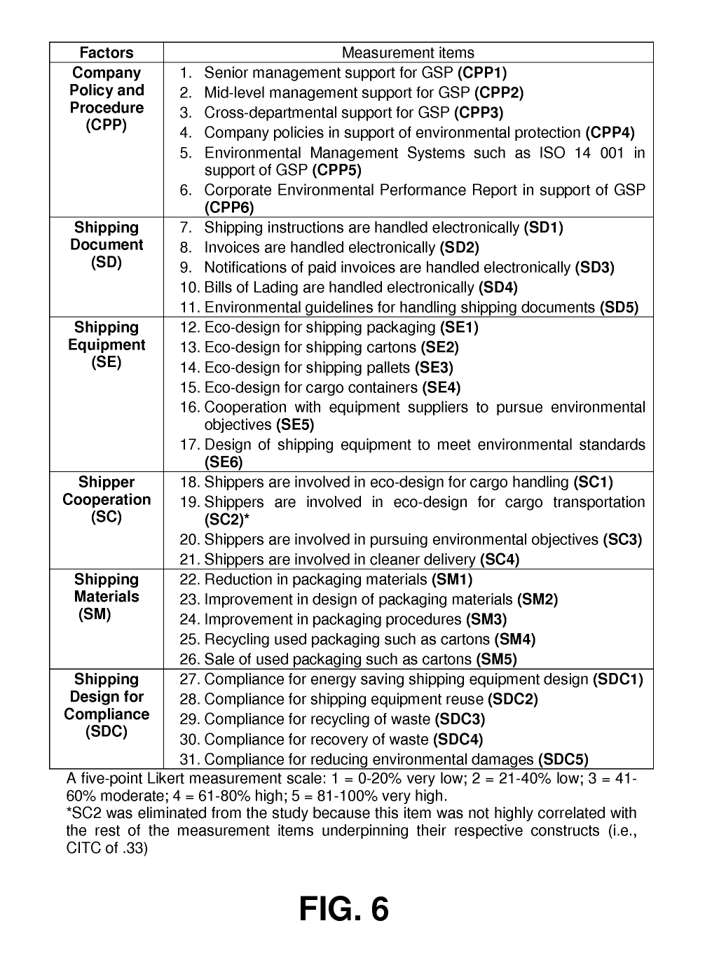

In developing a measurement instrument for evaluating GSP implementation, we followed the standard guidelines to ensure the key components of validity with respect to content, discriminant, convergent, and nomological validity (Bagozzi, Li, & Phillips, 1991). Using the inputs from an earlier study (Lai et al., 2011), together with the insights from twelve professionals in an international shipping forum, we generated a list of 31 items on GSP that are considered important for implementation by shipping firms: six for CPP, five for SD, six for SE, four for SC, five for SM, and five for SDC, where the items are summarized in FIG. 6. These items are measured on a five-point Likert scale, where 1=very low, 2=low, 3=moderate, 4=high, and 5=very high, to measure the extent to which the GSP were implemented in the company. We conducted a content validation test by inviting experts in the shipping industry to review the measuring items, so as to ensure that they are representative of our conceptualization of GSP implementation. We invited five shipping logistics experts from academia and five industry practitioners to review the questionnaire to ensure the relevance and clarity (i.e., face validity) of the descriptions for each item in the measurement scale. We explained to the experts the purpose of our study and asked them to comment on the items for completeness, understandability, terminology used, and ambiguity. We made several changes to improve the wording after the expert review and refined the questionnaire items in a pilot test.

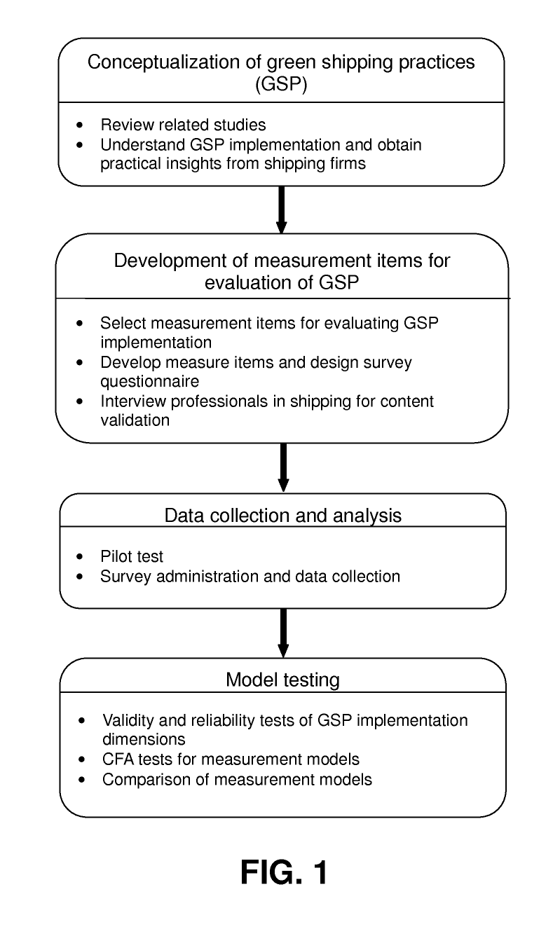

We initially pilot tested the measurement scale for evaluating GSP implementation with 30 managers attending a postgraduate master's programme in international shipping and transport logistics. The pilot test sought their feedback with a view to improving the wording and seminal meanings of individual measurement items for content validity. Subsequently, we organized the refined measurement items collectively as a measurement scale in the form of survey questionnaire for administering to a sample of shipping companies to capture the status of GSP implementation in the shipping industry. To evaluate the construct of GSP implementation, we carried out CFA tests to examine the measurement properties of GSP implementation, followed by a comparison of the test results of two alternative measurement models to evaluate the GSP implementation construct. FIG. 1 summarizes the methodology that guides the research process of this study.

### B.2 Data Collection

We identified a sample of 500 shipping companies from a population of 1,266 shipping companies listed in Shipping Gazette, a biweekly magazine published by the shipping industry in Hong Kong. We employed the key informant strategy to carry out the survey research. The target respondents were general operations managers of the sampled companies. Each target respondent received an initial mailing, which consisted of a covering letter explaining the purposes of the study, a copy of the questionnaire, and a postage-paid return envelope. Approximately one month later, we sent a second mailing identical in content to the initial one to the non-respondents, followed by a reminder letter two weeks after the second mailing. We received a total of 107 usable questionnaires, yielding a valid response rate of 21.4%.

### B.3 Non-Response Bias and Common Method Variance

We examined non-response bias by comparing the responses from the first mailing of the questionnaire with the responses from the second mailing by testing for the mean differences in the six dimensions of GSP implementation (Armstron & Overton, 1977). We found no significant differences (i.e., p>0.05) in the mean value of the six dimensions between the early and late respondents. Although the test results do not rule out the possibility of bias due to non response, they suggest that such a problem should not be an issue for this study to the extent that the late respondents represent the opinions of the non-respondents.

Common method variance might be a threat in this study due to the cross-sectional and key-informant research design. We therefore checked for such problem in three steps. First, we divided the survey questions into different sections based on the position of their respective variables in the model, e.g., dependent and independent (Podsakoff, MacKenzie, Lee, & Podsakoff, 2003). Second, following prior studies on environmental management and shipping, we conducted the Harman's one-factor test to ensure that no single factor accounts for the majority of covariance between the independent and dependent variables. The factor analytic results indicate that no one factor explains more than 40% of the total variance, which suggests that common method variance should not be a problem for this study. Lastly, we followed Lindell and Whitney's (Lindell & Whitney, 2001) guideline to test if there is a relationship between a marker variable (i.e., the variable that is theoretically not related to any variable in this study) and the six dimensions of GSP implementation. We used type of firm ownership as the marker variable and we found no significant relationship between it and the GSP implementation dimensions, so the potential threat due to common method bias was not apparent.

### C. Results of the Investigation

### C.1 Reliability Test

Before proceeding to conduct various multivariate tests, we first examined the skewness and kurtosis scores of each item to ensure there is no serious deviation from the normality assumption (Hair, Black, Babin, & Anderson, 2010). All of these scores fall within the range of −2 to +2 (skewness: −0.90 to 1.10; kurtosis −0.94 to 1.18), suggesting no violation of the normality assumption and the data quality is assured.

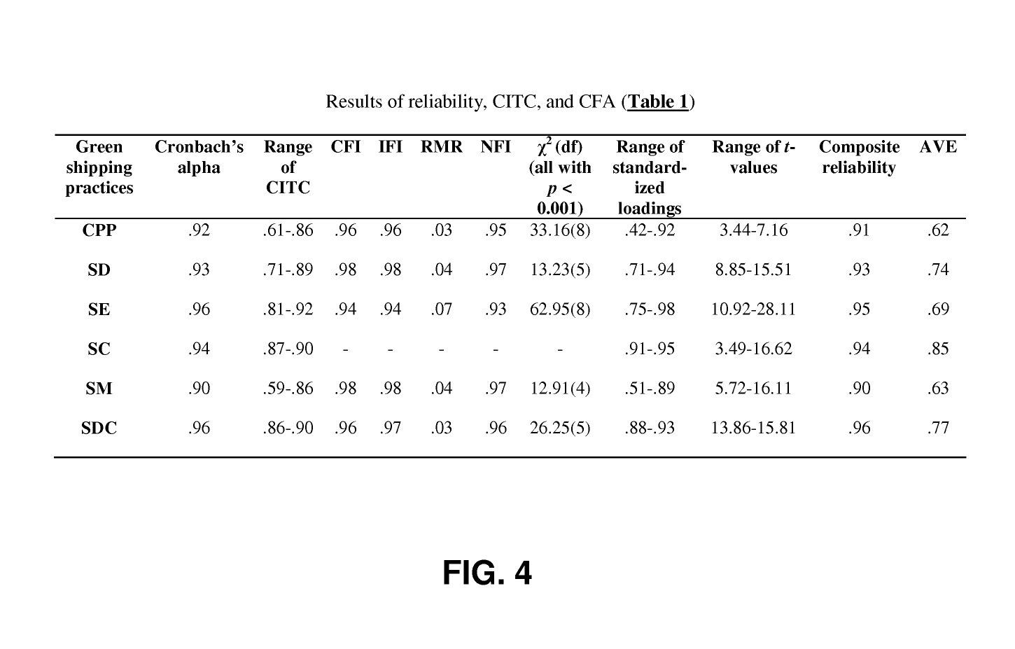

To assess the measurement properties of GSP implementation, we first conducted the reliability test and corrected item-to-total correlation (CITC) analysis, followed by confirmatory factor analysis (CFA). We used CFA to assess how well the observed variables reflect unobserved or latent variables. Table 1, shown in FIG. 4, summarizes the Cronbach's alphas for the six dimensions and the CITC results. All the six factors of GSP implementation have a Cronbach's alpha and composite reliability greater than the recommended threshold value of 0.70 (Formell & Larcker, 1981; Nunnally & Berstein, 1994) and all the CITC results are greater than 0.50 (Churchill, 1979), except for the item Shipper Cooperation (SC2), which has a CITC result of 0.33. While the CITC analysis assesses how well all the items are highly correlated if they belong to the same domain of concept, we eliminated SC2 for further analysis because this item is not highly correlated with the rest of the measurement items underpinning their respective constructs. Also, upon careful examination of its content, shippers tended not to involve eco-design in transportation, rendering this item inappropriate as part of the shipper cooperation (SC) construct.

### C.2 Convergent and Discriminant Validity

We next performed a CFA using the maximum likelihood estimation with AMOS 18.0. We used a multiple of goodness-of-fit indices to evaluate the fit of the factor structure of the CFA. The criteria of these indices for evaluating fitness are: comparative fit index (CFI)>0.9, incremental fit index (IFI)>0.9, root mean square residual (RMR)<0.1, and normal fit index (NFI)>0.9 (Hu & Bentler, 1999). Table 1, shown in FIG. 4, summarizes the goodness-of-fit indices for the CFA. To test the convergent validity of the measurement scale, we followed Formell and Larcker (1981) and calculated the AVE values. The AVE of each construct exceeds the recommended minimum value of 0.5, which indicates convergent validity. The significant loading of the measurement items on their latent factors (λ>0.4 and t>2) provides further support for convergent validity. We also followed Formell and Larcker (1981) to test discriminant validity. The square root of AVE of each construct is greater than the correlation between any pair of them. This suggests that the relationship between the measurement items of their respective construct is greater than the relationship of the measurement items across constructs. This result provides evidence of discriminant validity.

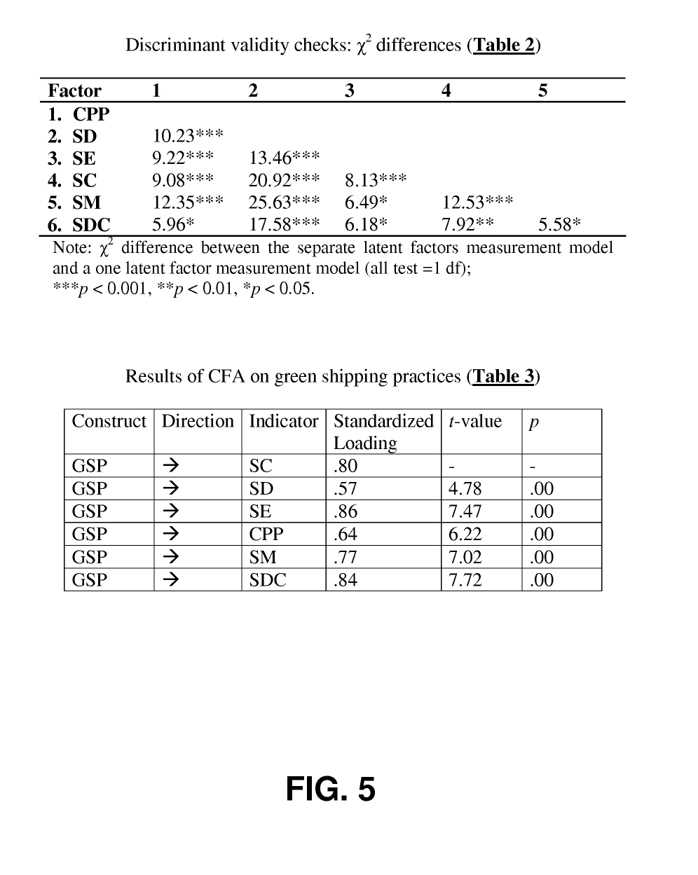

We conducted a series of χ² difference tests between nested CFA models for all pairs of constructs to assess the discriminant validity of the constructs to examine the degree to which each construct and its measurement items are different from another construct and its measurement items (Churchill, 1979). We compared the χ² between the constrained model, where the correlations between two constructs are constrained to 1.0, and the unconstrained model, where the two constructs vary freely (Bagozzi, Yi, & Phillips, 1991). Table 2, shown in FIG. 5, summarizes the χ² of the unconstrained and constrained models. Significant χ² differences between all pairs of constructs indicate discriminant validity.

### C.3 First-Order and Second-Order Models

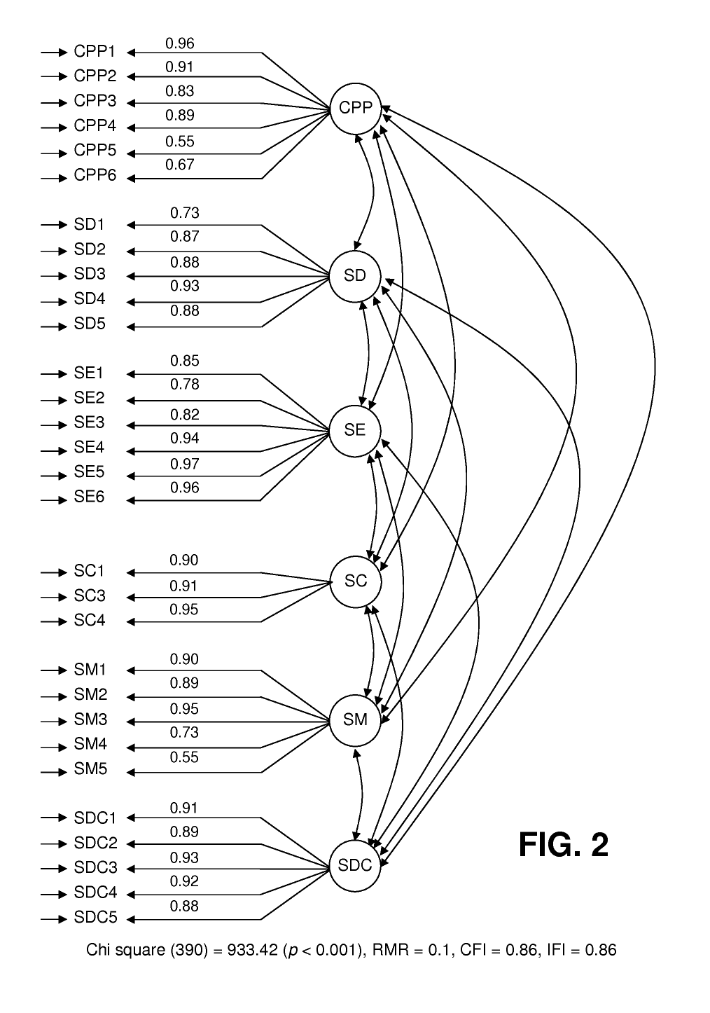

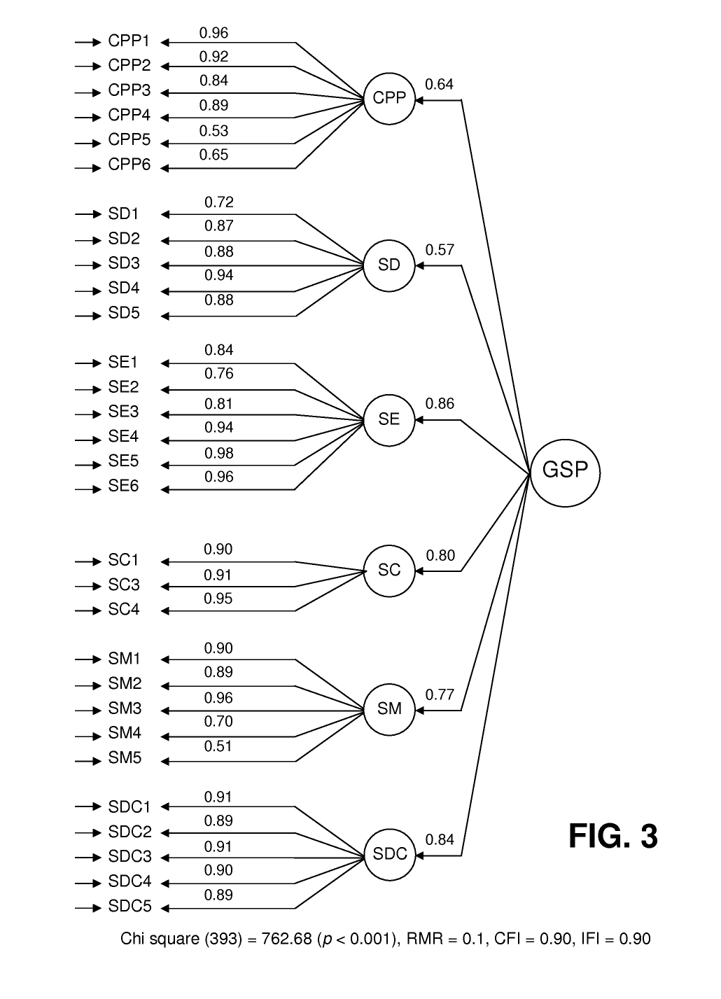

Having achieving satisfactory reliability and validity results, based on the concept of multiple dimensions of the GSP implementation construct, we tested if the construct should be a more parsimonious measure as a second-order level construct consisting of sub-dimensions including CPP, SD, SE, SC, SM, and SDC. We conducted three tests to compare the first-order (χ²=933.42, df=390, CFI=0.86, IFI=0.86, RMR=0.1) (see FIG. 2) and second-order (χ²=762.68, df=393, CFI=0.90, IFI=0.90, RMR=0.1) models as shown in FIG. 3, which are found to be almost identical. The second-order model is more restrictive and provides more information about the relationship between the higher-order GSP implementation construct and the lower-order factors in the form of path coefficients rather than correlations. This result suggests that the second-order model is a better predictor of GSP implementation. Moreover, the first-order constructs load significantly onto the second-order construct at p<0.05 with λ ranging from 0.57 to 0.86, providing support for the presence of the second-order model. Lastly, we compute the target coefficient value (T) (Marsh & Hocevar, 1985) and found T=0.82, which is close to the theoretical upper limit of 1.0. This result indicates that the second-order construct accounts for 99% of the traits of the first-order constructs, providing further support for the presence of the second-order model. Table 3, shown in FIG. 5, summarizes the CFA results on the GSP implementation construct.

### C.4 Nomological and Predictive Validity Test

To test for nomological validity of the GSP implementation scale regarding its ability to perform as expected in a network of well-established casual relationships and measures, we placed it within a nomological network of performance outcomes associated with different extents of GSP implementation. We developed the performance measures on the basis of Lai et al. (2002) and Lai, Wong, & Cheng (2010) for evaluating logistics performance in terms of cost (i.e., profitability, sales growth, operations cost reduction) and service (i.e., customer satisfaction, unforeseen problem-solving ability, and environmental performance) improvements over the last three years.

We used SEM to test the relationships between GSP implementation and logistics performance in the nomological network. The hypothesized model was supported, suggesting nomological validity of the GSP implementation scale. GSP implementation in shipping firms is significant and positively related to their cost reduction (β=0.46, p<0.01) and environmental performance (β=0.62, p<0.01). The predictive power of the model is also good as the model explains a good portion of the variance in cost reduction (R²=0.22) and service performance (R²=0.38).

### D. Discussion

In this study we develop the construct of GSP implementation and validate the measurement scale for evaluating the dimensions of GSP implementation. The measurement items underpinning the scale for GSP implementation are classified into six dimensions: CPP, SD, SE, SC, SM, and SDC. Among the 31 items validated in the survey study, the construct of GSP implementation adequately fits into the data collected, excluding SC2. This item was eliminated due to a lack of correlation with the rest of the measurement items underpinning their respective constructs. We further discovered that shippers tend not to involve in transportation eco-design as a part of their GSP implementation. In the model testing, both the first- and second-order models are validated while the second-order model is considered to be a better predictor, which indicates that the GSP construct should be treated as a higher order model governing the covariance of the six dimensions encompassing CPP, SD, SE, SC, SM, and SDC. In the first-order model, CPP, SD, SE, SC, SM, and SDC are correlated measurement factors for GSP implementation. The second-order model's estimated parameters are all significant and it is more restrictive with the provision of more information about the relationship between the higher-order GSP implementation construct and the lower-order factors in path coefficients in addition to the correlating relationships. Thus, the second-order model appears to be a more appropriate predictor for studying GSP implementation. This result reflects that the consideration of GSP implementation should be multifaceted, which should not be limited to any individual item. GSP implementation should cover all the six identified dimensions empirically validated in this study (i.e., CPP, SD, SE, SC, SM, and SDC). A lopsided focus on one dimension while neglecting the other dimensions can be devastating for overall performance outcomes because of the complementary nature of GSP implementation. The multidimensional conceptualization of the GSP implementation model provides insights into the construct of GSP implementation and its relationships with the underlying dimensions. First, the items and sub-dimensions of the construct are specific to the context of the shipping industry, so they provide direct and actionable suggestions for GSP implementation. Second, conceptualization of the construct at a higher level assists shipping firms to observe GSP implementation at an advanced level of abstraction beyond the individual items. At the individual item level, shipping companies may consider GSP implementation for each single item with a view to identifying areas in need of specific attention. The measurement items validated in this study provide shipping firms with a systematic guideline to evaluate their strengths and weaknesses in GSP implementation and also identify the areas that require improvement actions.

### E. Limitations of the Investigation

The first limitation is that the sample of respondents was selected from shipping firms and the study assesses information only from the perspective of sea transportation. Consequently, it offers a self-reported, one-dimensional focus. The study results could be different if the questionnaire data are collected from other transportation modes (e.g., air, land, rail) and stakeholders (e.g., shippers and consignees) within the transportation chain. Second, we focus on developing the measures for evaluating GSP implementation without a more in-depth investigation of the resulting performance outcomes. Performance measures of interest include cost, customer satisfaction, employee motivation, environmental, financial, productivity, market, and supply chain coordination (Wong, Lai, & Cheng, 2009; Wong, Lai, & Ngai, 2009; Wong, Boon-itt, & Wong, 2011). Moreover, a wider consideration of GSP implementation may be incorporated to provide a more comprehensive framework incorporating institutional factors such as the pressures from customers and legal requirements (Lai & Wong, 2012; Wong, Lai, Cheng, & Lun, 2011). Richer insights can be generated if studies are conducted across different cultural and social settings (Lai, Wong, & Cheng, 2012), which would help generalize the findings and understand the influences of cultural and social contexts on the development of GSP implementation.

### F. The Present Invention

As used herein, a “question” is defined as an expression of inquiry that invites or calls for a reply. An “answer” to a question is defined herein as a reply provided by the one that is enquired with such question. In particular, an absence of any expression in the reply is also deemed to be an answer unless it is specified to the contrary. An expression, if present, in the reply may be, but is not limited to, a numerical expression, a verbal expression, an oral expression, a hand signal, or any physical signal deemed to be a meaningful expression in reply to the question under consideration.

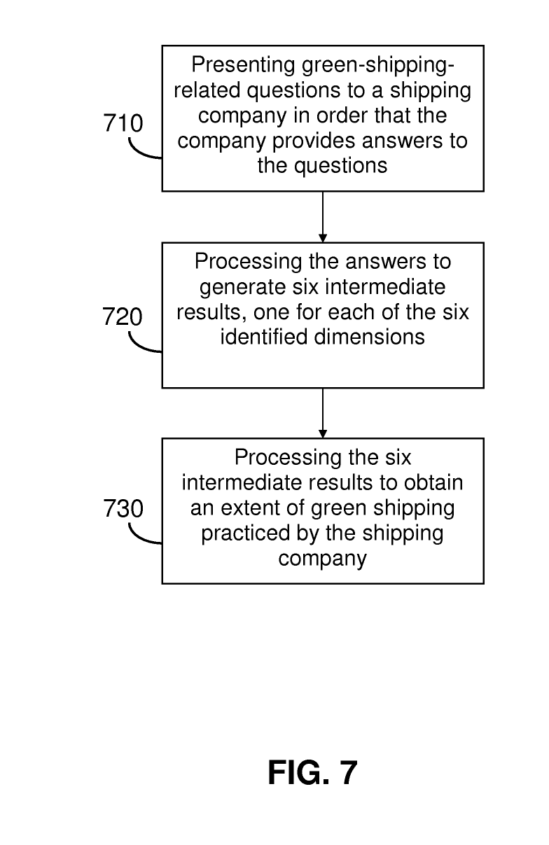

A first aspect of the present invention is a method for assessing an extent of green shipping activities practised by a shipping company. Based on the method, an apparatus for assessing an extent of green shipping activities practised by a shipping company is realizable. The method is illustrated as follows with an aid of FIG. 7.

In an exemplary embodiment, the method comprises a step 710 of presenting a plurality of green-shipping-related questions to the shipping company in order that the shipping company is enquired to provide an answer to each of the green-shipping-related questions. It follows that the shipping company receives the green-shipping-related questions and is allowed or invited to provide answers to these questions. The plurality of green-shipping-related questions comprises one or more questions related to a dimension of CPP, one or more questions related to a dimension of SD, one or more questions related to a dimension of SE, one or more questions related to a dimension of SC, one or more questions related to a dimension of SM, and one or more questions related to a dimension of SDC. According to a finding mentioned in Section D above, the aforementioned six dimensions constitute six identified dimensions empirically validated to be essential for assessing the extent of green shipping activities. The extent of green shipping activities can be evaluated through processing the answers to the one or more questions related to each of the six identified dimensions, allowing all the six identified dimensions to be considered in assessing the extent of green shipping activities. Optionally, each of the answers is numeric and is selected from one of five candidate answers where these five candidate answers are based on a 5-point Likert scale. An example of the 5-point Likert scale is mentioned in Section B.1 above.

Preferably, the method further comprises a step 720 of processing the answers to the green-shipping-related questions. In particular, the step 720 comprises: processing the answers to the one or more questions related to the dimension of CPP so as to generate a first intermediate result; processing the answers to the one or more questions related to the dimension of SD so as to generate a second intermediate result; processing the answers to the one or more questions related to the dimension of SE so as to generate a third intermediate result; processing the answers to the one or more questions related to the dimension of SC so as to generate a fourth intermediate result; processing the answers to the one or more questions related to the dimension of SM so as to generate a fifth intermediate result; and processing the answers to the one or more questions related to the dimension of SDC so as to generate a sixth intermediate result. It follows that one intermediate result is obtained for each of the six identified dimensions after processing the respective answers. Examples of a procedure for processing the answers are described as follows for the case that the answers are provided in a numerical format. The numerical answers, as indicated above, may be provided on a five-point Likert scale, which is mentioned in Section B.1 above. A first example of the processing procedure is that the numerical answers obtained for a dimension are arithmetically averaged to yield an intermediate result. This intermediate result provides information on the average performance achieved by the shipping company on the dimension under consideration. A second example of the processing procedure is that an intermediate result is given by the minimum value among the numerical answers for a dimension. This intermediate result enables the shipping company to identify an aspect in the GSP dimension where the shipping company performs the worst.

It is preferable that the method further comprises a step 730 of evaluating the extent of green shipping activities practised by the shipping company by processing the first, the second, the third, the fourth, the fifth, and the sixth intermediate results without neglecting any one of the six intermediate results. It enables all the six identified dimensions to be considered in assessing the extent of green shipping activities. Referring to the first example above, one may, for instance, characterize the extent of green shipping activities by averaging the six intermediate results. The extent of green shipping activities so calculated may be indicative to the overall performance achieved by the shipping company on green shipping activities. This calculated value may be compared with similar values obtained for other shipping companies so as to help a shipper in making a decision on selecting among candidate shipping companies. Referring to the second example above, one may characterize the extent of green shipping activities by finding the minimum value among the six intermediate results. The resultant value of the extent of green shipping activities may be indicative to the worst-case performance achieved by the shipping company in green shipping.

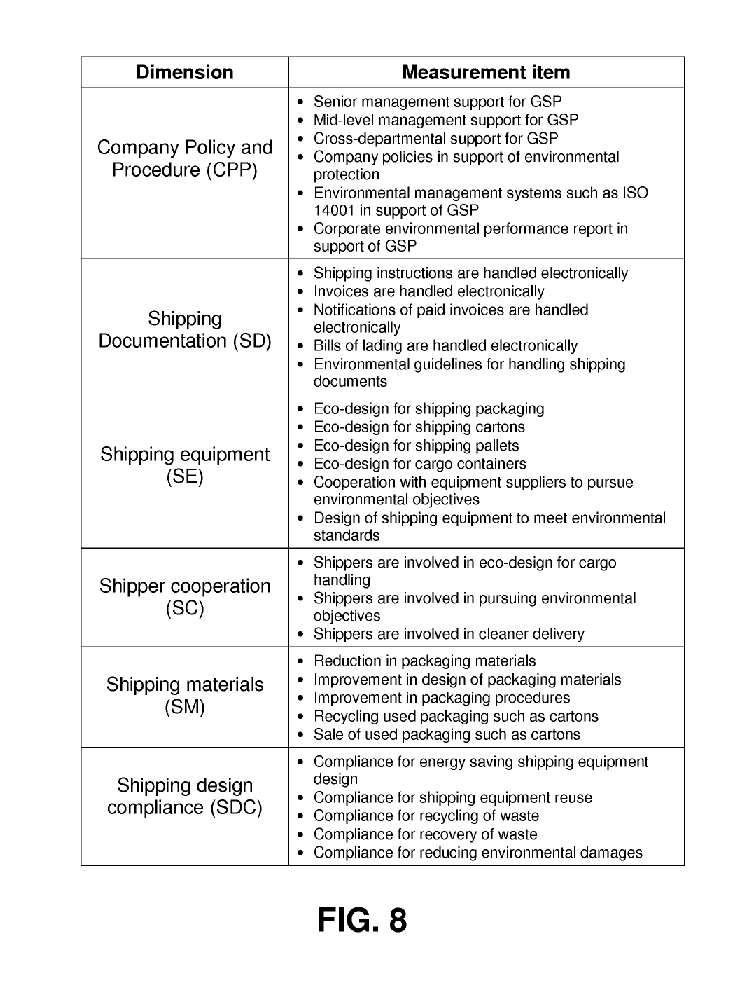

According to a finding mentioned in Section C.1 and Section D above, 30 measurement items have been validated that each of these measurement items belongs to the same domain of concept with its associated dimension. FIG. 8 lists the 30 measurement items and their associated dimensions. This finding is utilized in the present invention as illustrated as follows.

Preferably, an entirety of the one or more questions related to the dimension of CPP comprises one or more questions each of which is concerned with any of following measurement items or equivalents thereof: “senior management support for GSP”; “mid-level management support for GSP”; “cross-departmental support for GSP”; “company policies in support of environmental protection”; “environmental management systems such as ISO 14001 in support of GSP”; and “corporate environmental performance report in support of GSP”.

Preferably, an entirety of the one or more questions related to the dimension of SD comprises one or more questions each of which is concerned with any of following measurement items or equivalents thereof: “shipping instructions are handled electronically”; “invoices are handled electronically”; “notifications of paid invoices are handled electronically”; “bills of lading are handled electronically”; and “environmental guidelines for handling shipping documents”.

Preferably, an entirety of the one or more questions related to the dimension of SE comprises one or more questions each of which is concerned with any of following measurement items or equivalents thereof: “eco-design for shipping packaging”; “eco-design for shipping cartons”; “eco-design for shipping pallets”; “eco-design for cargo containers”; “cooperation with equipment suppliers to pursue environmental objectives”; and “design of shipping equipment to meet environmental standards”.

Preferably, an entirety of the one or more questions related to the dimension of SC comprises one or more questions each of which is concerned with any of following measurement items or equivalents thereof: “shippers are involved in eco-design for cargo handling”; “shippers are involved in pursuing environmental objectives”; and “shippers are involved in cleaner delivery”.

Preferably, an entirety of the one or more questions related to the dimension of SM comprises one or more questions each of which is concerned with any of following measurement items or equivalents thereof: “reduction in packaging materials”; “improvement in design of packaging materials”; “improvement in packaging procedures”; “recycling used packaging such as cartons”; and “sale of used packaging such as cartons”.

Preferably, an entirety of the one or more questions related to the dimension of SDC comprises one or more questions each of which is concerned with any of following measurement items or equivalents thereof: “compliance for energy saving shipping equipment design”; “compliance for shipping equipment reuse”; “compliance for recycling of waste”; “compliance for recovery of waste”; and “compliance for reducing environmental damages”.

Further examples on the use of the disclosed method are given as follows. In these examples, the method is used as a self-diagnostic tool for evaluating green shipping practices for shipping companies. In addition, a 5-point Likert scale shown in Section B.1 is used as a set of five candidate answers (i.e. 1=very low, 2=low, 3=moderate, 4=high, and 5=very high, to indicate an extent to which the GSP are implemented in a company) for a shipping company to provide a score (i.e. an answer) to each green-shipping-related question.

In one example, it is intended that the disclosed method enables a user using this method to understand extents of green shipping practices implemented in shipping firms, and to identify the shipping firms' performance strengths and weaknesses. To evaluate performance with respect to each of the measurement items, the user can compare the shipping firms' self-evaluated score points on an item against the medium point, i.e. a 3.0 value, of the scale. An item (or a collection of items for the six identified dimensions) attaining a score point 3.0 or below indicates poor performance in that area, and an item (or a collection of items for a particular area) attaining a score point above 3.0 indicates good performance in that area.

Another example is that, in evaluating green shipping practices at a higher level of abstraction for the first-order factor structure (CPP—six items, SD—five items, SE—six items, SC—three items, SM—five items, and SDC—five items) and for the second-order factor structure (GSP—30 items altogether), the user can take an average of the scores of underlying items and compare the average value with the medium 3.0 point value of the five-point scale. A shipping firm achieving a value above 3.0 in GSP is regarded as a high performer, indicating that the firm has made conscientious efforts to enhance its GSP, whereas a shipping firm achieving a value of 3.0 or below is regarded as a low performer in that particular item (or a factor constituted by a corresponding collection of items).

A further example is that a shipping firm's performance on a particular item (or a collection of items) in green shipping practices is a function of the score point the shipping firm assigns through self-evaluation to that particular item (or a collection of items) on the five-point Likert scale. An evaluation value above 3.0 indicates good performance while an evaluation value below 3.0 indicates poor performance.

A second aspect of the present invention is a questionnaire configured to enquire a shipping company regarding its green shipping practices. The questionnaire comprises one or more questions related to a dimension of CPP, one or more questions related to a dimension of SD, one or more questions related to a dimension of SE, one or more questions related to a dimension of SC, one or more questions related to a dimension of SM, and one or more questions related to a dimension of SDC. As mentioned above, these six dimensions constitute six identified dimensions empirically validated to be essential for assessing the extent of green shipping activities. As illustrative examples, the questionnaire may be realized in a physical form such as the form of a paper print-out, or as an electronic questionnaire presented to the shipping company via an electronic means, by a computer system or through a computer network.

Preferably, an entirety of the one or more questions related to each of the six dimensions comprises one or more questions each of which is concerned with any of measurement items shown in FIG. 8 for the dimension under consideration, or equivalents of such measurement items.

Optionally, the questionnaire further comprises a set of five candidate answers based on a 5-point Likert scale, such that each of the one or more questions related to any of the six identified dimensions is configured to be answered with an answer selected from one of the five candidate answers.

A third aspect of the present invention is related to systems for assessing an extent of green shipping activities practised by a shipping company, or each of a number of shipping companies.

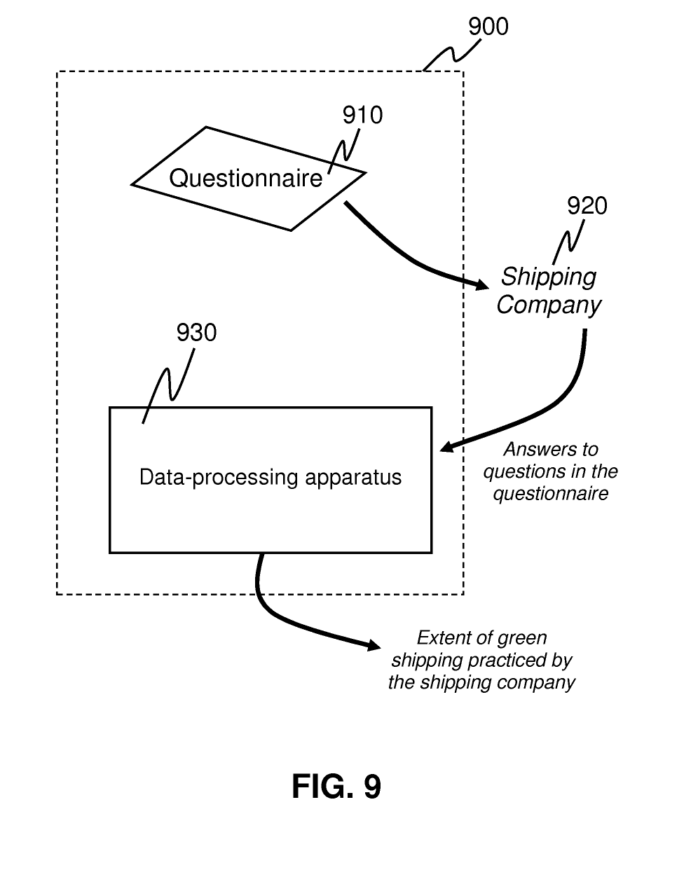

One embodiment is depicted in FIG. 9. A system 900 comprises a questionnaire 910 prepared according to the questionnaire disclosed above in the second aspect of the invention. A shipping company 920 is invited or allowed to provide answers to questions in the questionnaire 910. The system 900 further comprises a data-processing apparatus 930 configured to evaluate the extent of green shipping activities practised by the shipping company 920 when receiving the answers therefrom. In particular, the extent of green shipping activities is evaluated through processing the answers to the one or more questions related to each of the six identified dimensions to thereby allow all the six identified dimensions to be considered in assessing the extent of green shipping activities.

Preferably, the data-processing apparatus 930 is configured to execute a process that comprises: processing the answers to the one or more questions related to the dimension of CPP so as to generate a first intermediate result; processing the answers to the one or more questions related to the dimension of SD so as to generate a second intermediate result; processing the answers to the one or more questions related to the dimension of SE so as to generate a third intermediate result; processing the answers to the one or more questions related to the dimension of SC so as to generate a fourth intermediate result; processing the answers to the one or more questions related to the dimension of SM so as to generate a fifth intermediate result; and processing the answers to the one or more questions related to the dimension of SDC so as to generate a sixth intermediate result. It is also preferable that the process further comprises processing these six intermediate results without neglecting any one of them in order to evaluate the extent of green shipping activities practised by the shipping company 920. It enables all the six identified dimensions to be considered in assessing the extent of green shipping activities.

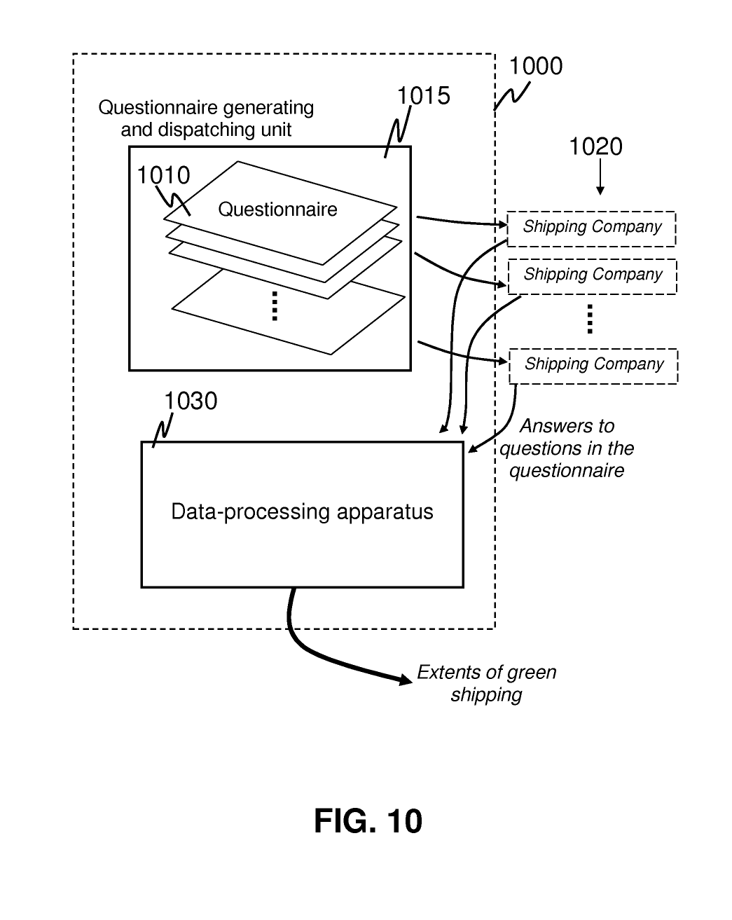

Another embodiment is depicted in FIG. 10. A system 1000 is configured to enquire a plurality of shipping companies 1020 on their green shipping practices and to assess an extent of green shipping activities practised by each of these companies. The system 1000 comprises a questionnaire generating and dispatching unit 1015 configured to generate a plurality of questionnaires 1010 and to dispatch one of the questionnaires 1010 to each of the shipping companies 1020. Each of the questionnaires 1010 is generated in accordance with the questionnaire disclosed above in the second aspect of the present invention. The system 1000 further comprises a data-processing apparatus 1030 configured to evaluate the extent of green shipping activities practised by a shipping company 1020 that returns answers to questions in a questionnaire 1010. The extent of green shipping activities is evaluated through processing the answers to the one or more questions related to each of the six identified dimensions, thereby allowing all the six identified dimensions to be considered in assessing the extent of green shipping activities.

### G. Examples of Apparatus Implementation of the Invention

Some embodiments of the present invention may be implemented in the form of software, hardware, or a combination of software and hardware. The software and/or hardware may reside on integrated circuit chips, modules or memories. If desired, part of the software and/or hardware may reside on integrated circuit chips, part of the software and/or hardware may reside on modules, and part of the software and/or hardware may reside on memories. In one embodiment, the software or an instruction set is maintained on any one of various conventional non-transitory computer-readable media.

Processes and logic flows which are described in this specification can be performed by one or more programmable processors executing one or more computer programs to perform functions by operating on input data and generating output. Processes and logic flows can also be performed by special purpose logic circuitry, e.g., an FPGA (field programmable gate array) or an ASIC (application-specific integrated circuit).

Apparatus described in this specification can be implemented by a programmable processor, a computer, a system on a chip, or combinations of them, by operating on input date and generating output. Apparatus can include special purpose logic circuitry, e.g., an FPGA (field programmable gate array) or an ASIC (application-specific integrated circuit). Apparatus can also include, in addition to hardware, code that creates an execution environment for computer program, e.g., code that constitutes processor firmware, a protocol stack, a database management system, an operating system, a cross-platform runtime environment, e.g., a virtual machine, or a combination of one or more of them.

Processors suitable for the execution of a computer program include, for example, both general and special purpose microprocessors, and any one or more processors of any kind of digital computer. Generally, a processor receives instructions and data from a read-only memory or a random access memory or both. The elements of a computer generally include a processor for performing or executing instructions, and one or more memory devices for storing instructions and data.

Computer-readable medium as described in this specification may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. Computer-readable media may include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

A computer program (also known as, e.g., a program, software, software application, script, or code) can be written in any programming language, including compiled or interpreted languages, declarative or procedural languages, and it can be deployed in any form, including as a stand-alone program or as a module, component, subroutine, object, or other unit suitable for use in a computing environment. A computer program can be deployed to be executed on one computer or on multiple computers that are located at one single site or distributed across multiple sites and interconnected by a communication network.

Embodiments and/or features as described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with one embodiment as described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

### H. Remark

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for assessing an extent of green shipping activities practised by a shipping company, the method comprising:
presenting a plurality of green-shipping-related questions to the shipping company in order that the shipping company is enquired to provide an answer to each of the green-shipping-related questions;
wherein the plurality of green-shipping-related questions comprises:
one or more questions related to a dimension of Company Policy and Procedure;
one or more questions related to a dimension of Shipping Documentation;
one or more questions related to a dimension of Shipping Equipment;
one or more questions related to a dimension of Shipping Cooperation;
one or more questions related to a dimension of Shipping Materials; and
one or more questions related to a dimension of Shipping Design Compliance;
the dimensions of Company Policy and Procedure, of Shipping Documentation, of Shipping Equipment, of Shipping Cooperation, of Shipping Materials and of Shipping Design Compliance being six identified dimensions empirically validated to be essential for assessing the extent of green shipping activities.

2. The method of claim 1, further comprising:
evaluating the extent of green shipping activities through processing the answers to the one or more questions related to each of the six identified dimensions, thereby allowing all the six identified dimensions to be considered in assessing the extent of green shipping activities.

3. The method of claim 1, wherein the answer to each of the green-shipping-related questions is selected from one of five candidate answers, the five candidate answers being based on a 5-point Likert scale.

4. The method of claim 1, further comprising:
processing the answers to the one or more questions related to the dimension of Company Policy and Procedure so as to generate a first intermediate result;
processing the answers to the one or more questions related to the dimension of Shipping Documentation so as to generate a second intermediate result;
processing the answers to the one or more questions related to the dimension of Shipping Equipment so as to generate a third intermediate result;
processing the answers to the one or more questions related to the dimension of Shipping Cooperation so as to generate a fourth intermediate result;
processing the answers to the one or more questions related to the dimension of Shipping Materials so as to generate a fifth intermediate result;
processing the answers to the one or more questions related to the dimension of Shipping Design Compliance so as to generate a sixth intermediate result; and
evaluating the extent of green shipping activities by processing the first, the second, the third, the fourth, the fifth, and the sixth intermediate results without neglecting any one of the six intermediate results, in order that all the six identified dimensions are considered in assessing the extent of green shipping activities.

5. The method of claim 1, wherein an entirety of the one or more questions related to the dimension of Company Policy and Procedure comprises one or more questions each of which is concerned with any of following measurement items or equivalents thereof:
“senior management support for GSP”;
“mid-level management support for GSP”;
“cross-departmental support for GSP”;
“company policies in support of environmental protection”;
“environmental management systems such as ISO 14001 in support of GSP”; and
“corporate environmental performance report in support of GSP”;
where GSP stands for Green Shipping Practices.

6. The method of claim 1, wherein an entirety of the one or more questions related to the dimension of Shipping Documentation comprises one or more questions each of which is concerned with any of following measurement items or equivalents thereof:
“shipping instructions are handled electronically”;
“invoices are handled electronically”;
“notifications of paid invoices are handled electronically”;
“bills of lading are handled electronically”; and
“environmental guidelines for handling shipping documents”.

7. The method of claim 1, wherein an entirety of the one or more questions related to the dimension of Shipping Equipment comprises one or more questions each of which is concerned with any of following measurement items or equivalents thereof:
“eco-design for shipping packaging”;
“eco-design for shipping cartons”;
“eco-design for shipping pallets”;
“eco-design for cargo containers”;
“cooperation with equipment suppliers to pursue environmental objectives”; and
“design of shipping equipment to meet environmental standards”.

8. The method of claim 1, wherein an entirety of the one or more questions related to the dimension of Shipping Cooperation comprises one or more questions each of which is concerned with any of following measurement items or equivalents thereof:
“shippers are involved in eco-design for cargo handling”;
“shippers are involved in pursuing environmental objectives”; and
“shippers are involved in cleaner delivery”.

9. The method of claim 1, wherein an entirety of the one or more questions related to the dimension of Shipping Materials comprises one or more questions each of which is concerned with any of following measurement items or equivalents thereof:
“reduction in packaging materials”;
“improvement in design of packaging materials”;
“improvement in packaging procedures”;
“recycling used packaging such as cartons”; and
“sale of used packaging such as cartons”.

10. The method of claim 1, wherein an entirety of the one or more questions related to the dimension of Shipping Design Compliance comprises one or more questions each of which is concerned with any of following measurement items or equivalents thereof:
“compliance for energy saving shipping equipment design”;
“compliance for shipping equipment reuse”;
“compliance for recycling of waste”;
“compliance for recovery of waste”; and
“compliance for reducing environmental damages”.

11. A questionnaire configured to enquire a shipping company regarding its green shipping practices, the questionnaire comprising:
one or more questions related to a dimension of Company Policy and Procedure;
one or more questions related to a dimension of Shipping Documentation;
one or more questions related to a dimension of Shipping Equipment;
one or more questions related to a dimension of Shipping Cooperation;
one or more questions related to a dimension of Shipping Materials; and
one or more questions related to a dimension of Shipping Design Compliance;
the dimensions of Company Policy and Procedure, of Shipping Documentation, of Shipping Equipment, of Shipping Cooperation, of Shipping Materials and of Shipping Design Compliance being six identified dimensions empirically validated to be essential for assessing an extent of green shipping activities practised by the shipping company.

12. The questionnaire of claim 11, further comprising a set of five candidate answers based on a 5-point Likert scale, such that each of the one or more questions related to any of the six identified dimensions is configured to be answered with an answer selected from one of the five candidate answers.

13. The questionnaire of claim 11, wherein an entirety of the one or more questions related to the dimension of Company Policy and Procedure comprises one or more questions each of which is concerned with any of following measurement items or equivalents thereof:
“senior management support for GSP”;
“mid-level management support for GSP”;
“cross-departmental support for GSP”;
“company policies in support of environmental protection”;
“environmental management systems such as ISO 14001 in support of GSP”; and
“corporate environmental performance report in support of GSP”;
where GSP stands for Green Shipping Practices.

14. The questionnaire of claim 11, wherein an entirety of the one or more questions related to the dimension of Shipping Documentation comprises one or more questions each of which is concerned with any of following measurement items or equivalents thereof:
“shipping instructions are handled electronically”;
“invoices are handled electronically”;
“notifications of paid invoices are handled electronically”;
“bills of lading are handled electronically”; and
“environmental guidelines for handling shipping documents”.

15. The questionnaire of claim 11, wherein an entirety of the one or more questions related to the dimension of Shipping Equipment comprises one or more questions each of which is concerned with any of following measurement items or equivalents thereof:
“eco-design for shipping packaging”;
“eco-design for shipping cartons”;
“eco-design for shipping pallets”;
“eco-design for cargo containers”;
“cooperation with equipment suppliers to pursue environmental objectives”; and
“design of shipping equipment to meet environmental standards”.

16. The questionnaire of claim 11, wherein an entirety of the one or more questions related to the dimension of Shipping Cooperation comprises one or more questions each of which is concerned with any of following measurement items or equivalents thereof:
“shippers are involved in eco-design for cargo handling”;
“shippers are involved in pursuing environmental objectives”; and
“shippers are involved in cleaner delivery”.

17. The questionnaire of claim 11, wherein an entirety of the one or more questions related to the dimension of Shipping Materials comprises one or more questions each of which is concerned with any of following measurement items or equivalents thereof:
“reduction in packaging materials”;
“improvement in design of packaging materials”;
“improvement in packaging procedures”;
“recycling used packaging such as cartons”; and
“sale of used packaging such as cartons”.

18. The questionnaire of claim 11, wherein an entirety of the one or more questions related to the dimension of Shipping Design Compliance comprises one or more questions each of which is concerned with any of following measurement items or equivalents thereof:
“compliance for energy saving shipping equipment design”;
“compliance for shipping equipment reuse”;
“compliance for recycling of waste”;
“compliance for recovery of waste”; and
“compliance for reducing environmental damages”.

19. A system for assessing an extent of green shipping activities practised by a shipping company, the system comprising:
the questionnaire of claim 12, allowing the shipping company to provide answers to questions therein; and
a data-processing apparatus configured to evaluate the extent of green shipping activities practised by the shipping company when receiving said answers, wherein the extent of green shipping activities is evaluated through processing the answers to the one or more questions related to each of the six identified dimensions, thereby allowing all the six identified dimensions to be considered in assessing the extent of green shipping activities.

20. A system configured to enquire a plurality of shipping companies on their green shipping practices and to assess an extent of green shipping activities practised by each of the shipping companies, the system comprising:
a questionnaire generating and dispatching unit configured to generate a plurality of questionnaires and to dispatch one of the questionnaires to each of the shipping companies, wherein each of the questionnaires comprises:
one or more questions related to a dimension of Company Policy and Procedure;
one or more questions related to a dimension of Shipping Documentation;
one or more questions related to a dimension of Shipping Equipment;
one or more questions related to a dimension of Shipping Cooperation;
one or more questions related to a dimension of Shipping Materials; and
one or more questions related to a dimension of Shipping Design Compliance;
the dimensions of Company Policy and Procedure, of Shipping Documentation, of Shipping Equipment, of Shipping Cooperation, of Shipping Materials and of Shipping Design Compliance being six identified dimensions empirically validated to be essential for assessing the extent of green shipping activities practised by each of the shipping companies; and
a data-processing apparatus configured to evaluate the extent of green shipping activities practised by each of the shipping companies when receiving answers provided by said each of the shipping companies to questions in one of the questionnaires, wherein the extent of green shipping activities is evaluated through processing the answers to the one or more questions related to each of the six identified dimensions, thereby allowing all the six identified dimensions to be considered in assessing the extent of green shipping activities.
